(19) United States
(12) Patent Application Publication
(10) Pub. No.: US 2009/0317620 A1
(43) Pub. Date: Dec. 24, 2009

(54) NARROW FACE OF A FURNITURE COMPONENT AND PRODUCTION METHOD

(75) Inventor: Andreas Kirschner, Rheda-Wiedenbruck (DE)

Correspondence Address: Fleit Gibbons Gutman Bongini & Bianco PL, 21355 EAST DIXIE HIGHWAY, SUITE 115, MIAMI, FL, 33180, US

(73) Assignee: RUDOLF HENRICHSMEYER FORMAPLAN GMBH & CO. KG, Hovelhof (DE)

(21) Appl. No.: 12/527,576

(22) PCT Filed: Jan. 23, 2008
(86) PCT No.: PCT/EP08/50736

§ 371 Date: Aug. 18, 2009

(30) Foreign Application Priority Data
Feb. 22, 2007 (DE) 10 2007 009 250.6

(51) Int. Cl. B32B 3/26; B32B 7/12; B32B 37/00

(52) U.S. Cl. 428/317.5; 428/304.4; 156/60; 156/160

(57) ABSTRACT

The invention relates to a furniture component (1) comprising a core (2), which is covered by a film (6) at least in the region of a narrow face (5; 11) and side surfaces (3, 4) of the core adjoining the same, and to a method for the production thereof. The aim of the invention is to enable the simple production of a smooth, stable and tight surface of the face of a furniture component covered with the film. This aim is achieved by a furniture component, wherein a smoothing layer (8; 12) for smoothing the surface of the face is provided between the face and the film, and by a method, wherein a smoothing material (8′; 12a, 12b, 12c) is applied to the face in order to form a smoothing layer, the film (6; 6′, 6′) is then applied to the face, and subsequently the film is applied to at least one first lateral surface adjoining the face and glued thereto.

The invention relates to a furniture component according to the preamble of Claim 1, as well as to a method for its production according to the preamble of Claim 9.

A known furniture component in the form of a drawer frame is known from DE 1 952 505 U. The drawer frame in that document features a frame core that is made from a pressboard guide rail that is brought to the desired cross-sectional shape through planing and milling. The pressboard guide rail is covered with a plastic sleeve with the exception of the lower narrow side and the cut end sides. Due to the plastic sleeve, the drawer frame features a higher quality look and feel than the rough pressboard rail guide. In this way, the pressboard rail guide is protected from external effects, for example, from water or contact, so that materials are prevented from leaving or entering or swelling the pressboard guide rail. To obtain the smoothest possible side faces of the drawer frame, sanded particle boards are typically used on the side faces, wherein pressboard guide rails are sawed, milled, or cut from these particle boards. The narrow cut faces on the upper and lower end faces are not post-treated, so that they feature rough, coarse, inhomogeneous, and uneven surfaces. This unevenness and work residue remaining on the end faces, e.g., sawing chips, become visible disadvantageously through the surrounding plastic film and disrupt the visual impression of the drawer frame, above all, for the end face that is visible from above in a drawer. This effect, which is also called telegraphing, is reinforced even more by the use of ever thinner plastic films. Above all, the disruptive visual impression of the drawer frames prevents the use of this class of furniture components in high-quality furniture. Also, with greater unevenness, the risk arises that the plastic film will become damaged during application onto the frame core or during use.

In order to avoid the mentioned disadvantages, currently the films are applied onto the corresponding end faces on the frame core with little play without the application of glue, so that a minimal air layer remains between the frame core and the plastic film. However, this method demands a very exact setting of the production equipment, in order to achieve optimum balance between the play and tension of the plastic film. If the plastic film is placed too loosely over the end face of the drawer frame, then the top edge cracks and rustles when the end faces are touched and, in the worst case, a fold is formed in the plastic film that considerably negatively affects the visual and perceived quality of the drawer frame or the drawers produced from this frame. Furthermore, there is the disadvantage that when furniture components produced in this way are cut to the desired drawer frame dimensions, the plastic film does not tear at the positions bonded with the end face.

DE 196 15 879 A1 discloses an alternative solution that relates to a method for finishing a particle board and also to a board produced with this method. In that document, a very smooth and uniform surface that is free from all unevenness and surface breaks is achieved in that a thin, level cover element is applied onto the end face of the board. After additional processing steps, the board is covered with a cover film that is placed over the cover element 3. The cover element is made from a solid, band-shaped material, for example, real wood, a wood-like carrier with synthetic coating, or a different textile coating. In the construction in that document, the disadvantage arises that a complicated and expensive feeding of an additional cover element is necessary that is also in danger of tearing.

DE 2 258 596 also relates to a method and to a device for coating board edges, wherein, here, carrier paper saturated with duroplastic resin is connected with this synthetic resin as edge strips across the entire edge surface of the board, wherein the synthetic resin must be activated before application. This requires an additional processing step in which the given conditions must also be maintained. This leads to a relatively high processing expense that is also associated with great care for maintaining the operating parameters for the synthetic resin.

DE 1 504 995 discloses a method and a device for hardening the edge of a polyurethane foamed layer structure. In that document, edge parts of a sandwich strip are heated by an endless belt and pressurized, so that the edge parts or the polyurethane foam forming these parts is driven inward. Thus, in that document, the polyurethane foamed layer board itself is deformed and used as a smoothing layer, which is not possible for a furniture component made from wood or from similar materials.

The problem of the present invention is therefore to overcome the aforementioned disadvantages and to disclose a furniture part as mentioned above and a method for its production that allows simple production in terms of processing of a smooth, stable, and rigid surface of the end face of a furniture component covered with film.

The problem is solved by a furniture component with the characteristics of Claim 1, as well as by a method for its production with the characteristics of Claim 9. Preferred constructions and advantageous refinements of the invention are specified in the dependent claims.

The furniture component as mentioned above is characterized in that the smoothing layer is made from a smoothing material that foams and hardens after application, wherein the free space between the end face and the film fills up completely due to the foaming and the film across the end face becomes rigid. The smoothing layer allows the end face of the furniture component to be surrounded smoothly and rigidly with the film, so that the end face is visually appealing and is more stable and less sensitive to pressure.

If the smoothing material also has adhesive properties, then the film cannot slip in any way on the end face.

The invention has an especially advantageous effect on a furniture component with a core made from wood or particle board, because the end face can then be smoothed without additional post-processing. In particular, for particle board cores, especially rough and uneven end face with telegraphing can be smoothed advantageously.

In another advantageous configuration of the invention, the smoothing layer and the film lying above it are adapted in a smoothing way to the shape of the end face, so that profiles of the end face with previously machined grooves, corrugations, or other profiles can have stable and smooth constructions.

Because the smoothing material is pressed at least partially into the rough surface of the end face of the furniture component, additional stabilization of the end face is achieved along with a good connection of the smoothing layer to the core of the furniture component.

Preferably, the invention is used in drawer frames, wherein the core is a frame core. Even for drawer frames, the surfaces of the end faces, in particular, the end faces pointing upward, are easily visible and subject to damage when a drawer is pulled out from a cabinet or the like.

The production method according to the invention allows the production of a furniture component with stable and smooth end faces, along with quick fabrication. The method can be used both for upper and for lower end faces of furniture components.

Additional details and advantages of the invention emerge from the following description of preferred embodiments with reference to the drawings. Shown are:

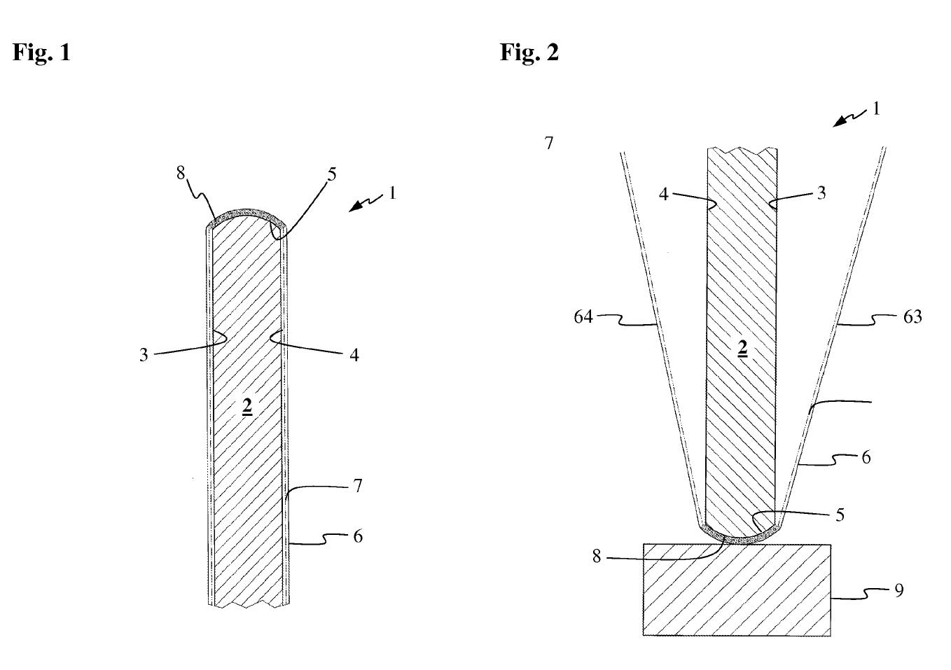

FIG. 1: a cross section through an enlarged section of a furniture component according to the invention in the form of a drawer frame,

FIG. 2: a cross section through the enlarged section shown in FIG. 1 of the drawer frame during the application of a film onto the frame core,

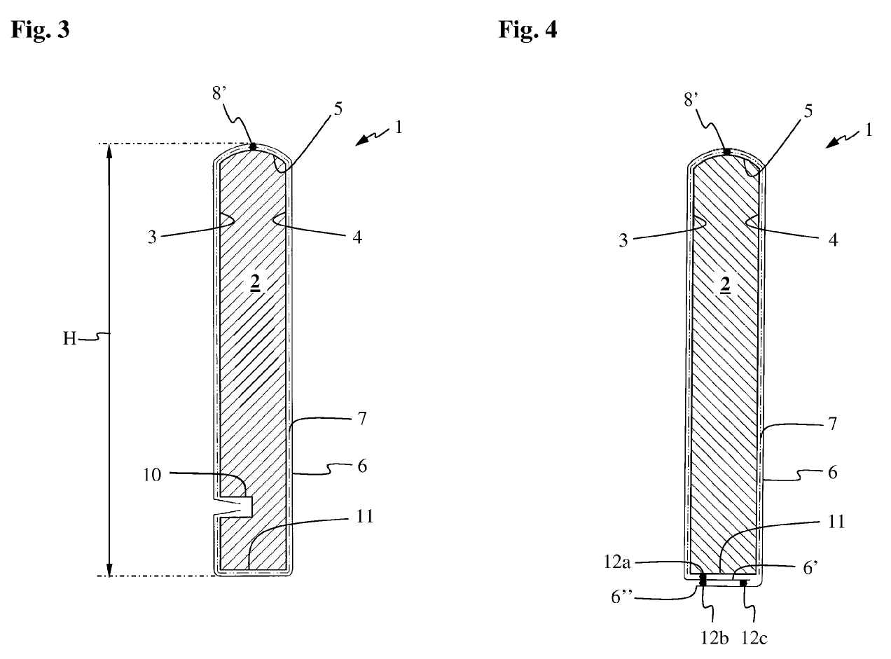

FIG. 3: a cross section through a first embodiment of a drawer frame with lateral groove,

FIG. 4: a cross section through a second embodiment of a drawer frame.

FIG. 1 shows a cross section through a section of a furniture component according to the invention in the form of a drawer frame that is called frame 1 below for the sake of simplicity. The frame 1 has a core 2 made from a pressed board that is cut from a rough particle board with sanded side faces to form a longitudinal, strip-shaped guide rail with the provided frame height H (FIG. 3). Side faces 3 and 4 of the core 2 then form the outer and inner side walls, respectively, of the frame 1.

The section illustrated in FIG. 1 of the frame 1 shows an upper end face 5 of the frame 1 or the core 2 that is visible, in a completed drawer, from above when the drawer is open. Because the end face 5 is cut from a rough particle board, the surface of the end face 5 is coarse, rough, uneven, and inhomogeneous.

The core 2 is surrounded by a film 6 made from plastic material, namely PVC. Alternatively, other plastic or paper films could be used instead. The film 6 is bonded to the side faces 3 and 4 by means of a typical casein glue, wherein the casein glue layer 7 is indicated in the drawings by a dotted line. Alternatively, another suitable adhesive could be used. No casein glue layer is applied onto the film 6 in the area of the surface of the end face 5. For production-related reasons, however, this surface could be provided with casein glue without causing a disadvantage in the invention.

In order to prevent telegraphing of the rough surface of the end face 5 through the very thin film 6, a smoothing layer 8 made from a smoothing material 8′ is introduced between the core 2 and film 6. For the smoothing material 8′, a so-called reactive, duroplastic adhesive, for example, polyurethane, is used. Other materials with the same properties could also be used for this purpose.

One production step of the frame 1, namely the production of the smoothing layer 8, is shown by FIG. 2. After the smoothing material 8′ is applied in the form of a bead (see FIGS. 3 and 4) onto the end face 5 of the core 2, the core 2 is set with the end face 5 onto the film 6; thus the film 6 is applied onto the end face 5. Then the two areas 63 and 64 of the film 6 coated with casein glue 7 are pulled or tensioned upward uniformly in FIG. 2 and placed on the side faces 3 and 4 of the core 2; thus they are applied, then coated smooth, and in this way adhered tightly to the side faces 3 and 4.

By drawing or tensioning the film 6 against the end face 5, the smoothing material 8′ is distributed uniformly across the end-face surface of the core 2 and pressed into the rough, uneven surface of the end face 5, so that it penetrates into the uneven, rough surface of the end face 5. Because the smoothing material 8′ undergoes foaming after the application and thus its volume increases, it completely fills up the intermediate space between the core 2 and film 6. In addition, in this way the film 6 is also tensioned in the region of the end face 5, wherein the film 6 does not tear due to its elasticity, but instead merely receives a smoother surface. In this way, after the hardening of the smoothing material 8′, the smooth and robust smoothing layer 8 is formed that equalizes the roughness and unevenness of the surface of the end face 5, covers it in a smooth way, and protects it from damage.

In addition, the smoothing material 8′ and also the upper film 6 in the region of the end face 5 could be adapted by pressure to a suitable profile shape or by the pressure of a profiled roller to the shape of the end face 5.

In a not-shown embodiment, instead of the rounded end face 5, a differently profiled end face, for example, with a central groove or straight end, could be provided with a smoothing layer. Here, instead of the sleeve channel 9 shown in FIG. 2 with rectangular cross section, a sleeve channel adapted to the desired profile of the end face could be used that presses the film into the profile of the end face.

In FIGS. 3 and 4, embodiments of the frame 1 are shown with identical end faces 5 at the top, wherein the upper section of the frame 1 corresponds to that shown in FIG. 1. Therefore, the same reference symbols are used for the same parts and below only the differences will be explained.

In the core 2 shown in FIG. 3, a groove 10 is milled at the lower end into the first side face 3 for holding a drawer base (not shown). The film 6 is adhered to the side faces 3, 4, the end-face surface 5, and also the lower end face 11, wherein the upper end face 5 has available a smoothing layer 8 according to the invention corresponding to the embodiment according to FIGS. 1 and 2. Both in FIGS. 3 and 4, the smoothing layer 8 of the upper end face 5 or the lower end face 11 is indicated only as a bead-shaped smoothing material 8′. The film 6 is merely placed into the groove 10, because the film 6 is pressed tightly onto the groove walls and held therein by the insertion of the drawer base. This raises the risk, however, that during production or during use of the drawer, the film 6 comes out from the groove 10. This is the case, for example, when the drawer base and the groove 10 are not exactly adapted to each other or the groove 10 expands differently than the drawer base due to different material properties of the core 2 and the drawer base. In order to prevent this, an exact production and consequently high production expense is needed.

In order to prevent the above disadvantages and to reduce the production expense for the frame 1, other fastening mechanisms for drawer bases have been provided for some time. In order to disclose suitable frames 1 for this purpose, the present invention is also used for the attachment of the film 6 to the lower end face 11 of the core 2 in FIG. 4 and for the formation of an additional smoothing layer 12 at this position.

For this purpose, smoothing material 12a is applied in the form of a bead between a first end 6′ of the film 6 and the lower end face 11 of the core 2. Then the film 6 is placed around the first side face 3, the upper end face 5, and the second side face 4 of the core 2 and adhered there as described above. Before, during, or after the application of the film 6 on the three different sides 3, 5, and 4 of the core 2, at least one additional bead-shaped section 12b of the smoothing material is applied onto the first end 6′ of the film 6 above the section 12a. In addition, advantageously another section 12c of the smoothing material is applied on top in the vicinity of the first end 6′ of the film 6.

Then a second end 6″ of the film 6 is pressed onto the first end 6′ of the film 6 lying on the lower end face 11 of the core 2. In this way, the smoothing material of the beads 12a, 12b, and 12c is distributed uniformly into the free spaces between the core 2 and the first end 6′ or between the first end 6′ and the second end 6″ of the film 6. In this way, the lower end face 11 of the frame 1 that has a rough, uneven, inhomogeneous surface just like the upper end face 5 due to the cutting of the core 2 from a rough particle board is also smoothed and made uniform. Because the smoothing material of the beads 12a, 12b, and 12c has the same properties as the smoothing material 8′ of the upper smoothing layer 8 and is also adhesive, the ends 6′ and 6″ of the film 6 are fixed tightly to the core 1 and to each other, wherein simultaneously a smooth surface is produced on the lower end face 11 of the frame 1 or the core 2.

1-14. (canceled)

15. Furniture component with a core that is covered at least in the region of a narrow end face and adjacent side faces of the core by a film, wherein a smoothing layer for smoothing the surface of the end face is provided between the end face and the film, wherein the smoothing layer is made from a smoothing material undergoing foaming and hardening after application.

16. Furniture component according to claim 15, wherein the smoothing material has adhesive properties.

17. Furniture component according to claim 15, wherein the core is made from wood or pressed board.

18. Furniture component according to claim 15, wherein the smoothing material and the above-lying film are adapted in a smoothing way to the profile of the end face.

19. Furniture component according to claim 15, wherein the smoothing material is pressed at least partially into the surface of the end face.

20. Furniture component according to claim 15, wherein the furniture component is a drawer frame.

21. Furniture component according to claim 15, wherein a first end of the film is applied onto the end face, the film onto the adjacent first side face, another end face opposite the end face, and the second side face and adhered at least partially to these faces, and a second end of the film opposite the first end is applied from the second side face in an overlapping manner onto the outside of the first end of the film on end face and is adhered to this film, wherein a smoothing layer is formed between the end face and the first end of the film and/or the first end of the film and the second end of the film.

22. Furniture component according to claim 21, wherein the one smoothing layer is formed by a smoothing material applied between the end face and the first end of the film and/or smoothing material applied to the first end of the film and the second end of the film.

23. Method for the production of a furniture component with a core that is covered at least in the region of a narrow end face and adjacent side faces of the core by a film, the method comprising the steps of:
a) applying a smoothing material for forming a smoothing layer to the end face, the smoothing material including a material undergoing foaming and hardening after application;
b) applying the film onto the end face; and
c) applying the film onto at least one first side face bordering the end face and adhered to this side face.

24. Method according to claim 23, wherein the smoothing material features adhesive properties.

25. Method according to claim 23, wherein the smoothing material is applied onto the end face in the form of a bead.

26. Method according to claim 23, wherein the film and the smoothing material located between the film and end face are adapted in a smoothing way to the profile of the end face.

27. Method according to claim 23, wherein:
b1) after step b), film regions and the film are tensioned against the end face and, in this way, the smoothing material for forming a smoothing layer is pressed at least partially into the surface of the end face, and
c1) in step c), the film is also applied onto a second side face of the core bordering the end face and opposite the first side face and adhered to this second side face.

28. Method according to claim 23, wherein:
b1) in step b), the film is applied with a first end onto the end face, then
c1) in step c), the film is applied onto the bordering first side face, another end face opposite the end face, and the second side face and adhered to these faces, simultaneously or at a later time,
d) smoothing material is applied onto the outside of the film applied onto the end face, and
e) a second end of the film opposite the first end overlapping the second side face is applied onto the outside of the first end of the film applied onto the end face and adhered to this second end.

29. Method according to claim 23, wherein steps a, b, and c are performed in order.
